(19) United States
(12) Patent Application Publication
(10) Pub. No.: US 2004/0092142 A1
(43) Pub. Date: May 13, 2004

(54) Clamping apparatus for connecting ground wire to grounding member

(75) Inventors: Reuben Clark, Cary, NC (US); Gary Weise, San Juan Capistrano, CA (US)

Correspondence Address: BURNS DOANE SWECKER & MATHIS L L P, POST OFFICE BOX 1404, ALEXANDRIA, VA, 22313-1404, US

(73) Assignee: Consolidated Manufacturing International, LLC

(21) Appl. No.: 10/689,465

(22) Filed: Oct. 20, 2003

Related U.S. Application Data
(60) Provisional application No. 60/424,604, filed on Nov. 7, 2002.

(51) Int. Cl. H01R 4/66

(52) U.S. Cl. 439/100

(57) ABSTRACT

A clamping apparatus for electrically connecting a ground wire to a grounding member includes a top and bottom clamping member operating in cooperation to apply clamping pressure to the grounding member. The top and bottom clamping members include medial portions and cooperating threaded holes on both sides of the respective medial portion. A screw passes through each hole to provide a clamping action around the ground member between the top and bottom clamping members when the screws are tightened. A trough is attached to the top clamping member on a side opposite the bottom clamping member. The trough includes a threaded hole in a first sidewall and a set screw adapted to tighten against a second sidewall, with an opening between the first and second sidewall. A ground wire is laid-in the trough through the opening at some intermediate point on the ground wire and the set screw is tightened.

### RELATED APPLICATIONS

This application claims priority under 35 U.S.C. § 119 to U.S. Provisional Application No. 60/424,604, filed on Nov. 7, 2002, the entire content of which is hereby incorporated by reference.

### BACKGROUND

The present invention is related to the electrical connection of ground wires, and more particularly to a clamping apparatus for reducing the labor associated with connecting ground wires to a grounding member.

Grounding clamps have been used to electrically connect electrical devices to a grounding member, such as rebar, pipe, and ground rods, in order to provide a proper ground for the electrical devices, where typically at least a portion of the grounding members are underground. More specifically, the grounding clamp is typically fastened around the grounding member by some adjustable clamping means. An electrically conductive cable, i.e., a ground wire, is attached to the grounding clamp by some means and also attached to a ground terminal at the electrical device, thereby providing a path for any ground currents from the electrical device through the grounding clamp down the grounding member and into the ground where it can be safely dissipated.

Many different grounding clamp designs have been disclosed in the prior art. The prior art grounding clamps, however, are labor intensive to install. The ground wire is attached via a hole in the body of the clamp somewhere. Some even require a two-part installation, where the hole for the ground wire is on a separate arm or body that must then be somehow attached to the clamp. In either case, this method requires an installer to pull the ground wire through the hole in the clamp. This is cumbersome and time consuming since the ground wire is relatively large in diameter with little extra clearance space available within the hole, which makes the ground wire somewhat difficult to maneuver, e.g., bend to the proper angle. The task is even more cumbersome and time consuming when an installer must attach multiple clamps to the same ground wire. In such a case, the ground wire must be pulled through the hole for long distances. For example, when grounding the vertical stud bolts at the bottom of a light pole the wire needs to be pulled through a first hole in a first clamp and then immediately bent to go around a corner to insert in another hole in another clamp, and so on.

The use of such labor intensive grounding clamps result in increased installation costs. Since highly paid electricians are employed for running and attaching the ground wire, it is desirable to minimize labor costs associated with the installation.

Accordingly, there is a need for a clamping apparatus that reduces installation time.

### SUMMARY

It is therefore an object of this invention to provide a clamping apparatus for electrically connecting a ground wire to a grounding member that reduces installation time.

It is another object to provide a clamping apparatus for electrically connecting a ground wire to a grounding member that allows the ground wire to be “laid-in” at some intermediate point to provide for a less cumbersome installation.

It is still another object to provide a clamping apparatus for electrically connecting two ground wires to a grounding member that allows both ground wires to be “laid-in” at some intermediate point to provide for a less cumbersome installation that also includes the mechanical and electrical connection of the two ground wires.

The present invention addresses these and other concerns. According to one aspect, a clamping apparatus for electrically connecting a ground wire to a grounding member includes a top and bottom clamping member operating in cooperation to apply clamping pressure to the grounding member. The bottom clamping member includes a bottom medial portion and a threaded hole on both sides of the bottom medial portion. The top clamping member includes a top medial portion aligned to cooperate with the bottom medial portion and corresponding holes on either side of a top medial portion that correspond to, and are slightly larger in diameter than, the threaded holes in the bottom clamping member to allow a screw to pass through each hole in the top clamping member and thread into the corresponding threaded hole in the bottom clamping member, thereby providing a clamping action around the ground member between the top and bottom clamping members when the screws are tightened.

The clamp further includes a trough comprising a base wall and a first and second side wall. The trough is attached via the base wall to the top medial portion of the top clamping member on a side opposite the bottom clamping member. The first sidewall includes a threaded hole and a set screw adapted to tighten against the second sidewall, wherein the trough is arranged with an opening between the first and second sidewall so that a ground wire can be laid-in the trough at some intermediate point on the ground wire and tightening the set screw applies clamping pressure to the ground wire between the set screw and the second side wall.

### BRIEF DESCRIPTION OF THE DRAWINGS

The above and other objects, features, and advantages of the present invention will become more apparent in light of the following detailed description in conjunction with the drawings, in which like reference numerals identify similar or identical elements, and in which:

FIG. 1 is a front view illustrating a clamping apparatus according to an embodiment of the invention;

FIG. 2 is a side view illustrating a clamping apparatus according to an embodiment of the invention;

FIG. 3 is a front view illustrating a clamping apparatus according to a second embodiment of the invention;

FIG. 4 is a side view illustrating a clamping apparatus according to the second embodiment of the invention;

FIG. 5 is a front view illustrating a clamping apparatus in use according to an embodiment of the invention;

FIG. 6 is a front view illustrating a conventional ground clamp; and

FIG. 7 is a front view illustrating a clamping apparatus accommodating the junction of two ground wires according to an embodiment of the invention.

### DETAILED DESCRIPTION

Preferred embodiments of the present invention are described below with reference to the accompanying drawings. In the following description, well-known functions and/or constructions are not described in detail to avoid obscuring the invention in unnecessary detail.

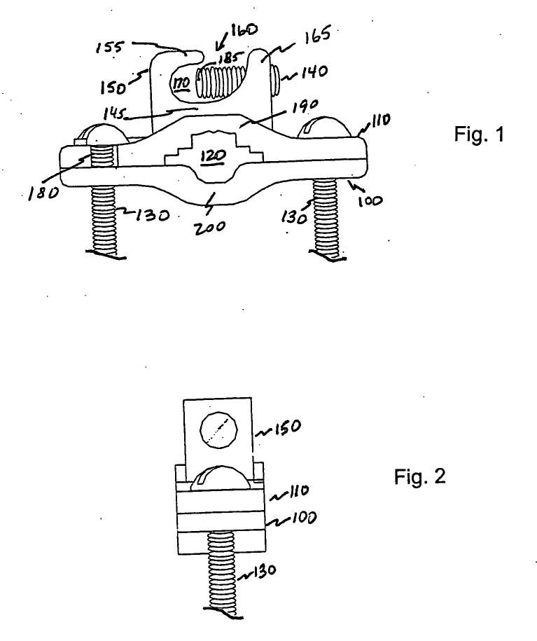

Turning to the drawings, FIG. 1 illustrates a clamping apparatus (clamp) used for grounding according to a first embodiment of the invention. FIG. 2 illustrates a side view of the clamp of FIG. 1. The clamp comprises bottom and top cooperating clamp members, 100 and 110, respectively. The bottom clamp member 100 includes a threaded hole at each side to allow the threading of two screws 130. The top clamp member 100 includes a respective cooperating slightly larger unthreaded hole at each side to allow the passage of the two screws 130 through the top clamp member 110 to be threaded into the bottom clamp member 100. One of the holes may be replaced by a slot 180 to allow the clamp to be opened by rotating the top clamping member about the opposing screw 130.

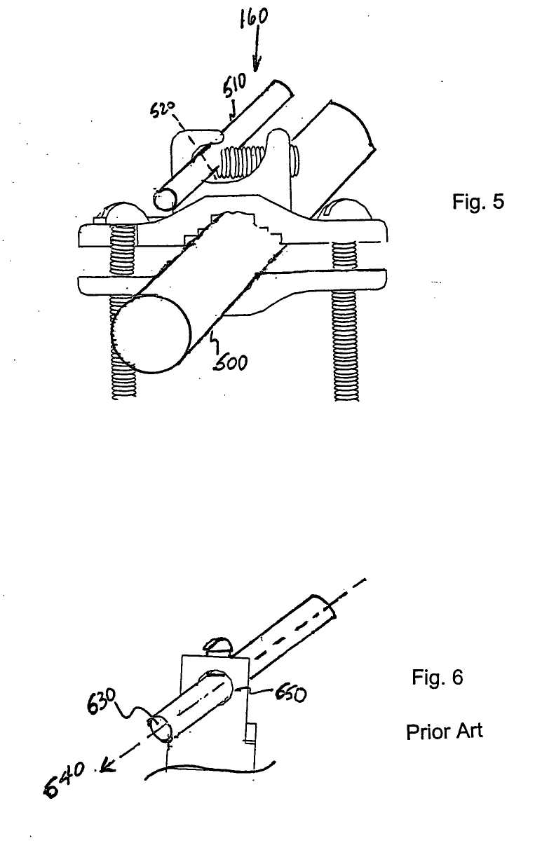

The top 110 and the bottom 100 member include a medial portion, 190 and 200, respectively, that is optionally of a crowned shape to form an opening 120 adapted for accepting a grounding member 500, such as a section of rebar, a pipe, or a ground rod, as shown in FIG. 5. In the illustrative embodiment of FIG. 1, both the top 110 and the bottom 100 grounding member include the crowned medial portion. It should, however, be understood that the crowned medial portion may be in only one of the grounding members or that when both clamping members include crowned medial portions 190, 200, the two portions need not be symmetrical. In any case, it is preferable to have at least one crowned medial portion to better adapt an opening 120 between the clamping members 100, 110 to the grounding member 500. The screws 130 are tightened and loosened to move the top 110 and bottom 100 members together and apart, respectively, to reduce and enlarge the size of the opening 120 to accept the grounding member 500. The screws 130 are tightened to apply pressure against the grounding member 500 by the clamping members 100, 110 to provide electrical contact between the clamp and grounding member 500. The inside surfaces of the top and bottom medial portions that surround the opening 120 are preferably serrated to improve electrical contact between the respective clamping member and grounding member 500.

A trough assembly 150 according to the invention is mechanically affixed or formed together with the top clamp member 110. The trough is adapted to allow the ground wire 510 to “lay in” from above the trough assembly 150 in a direction 160 shown. With reference to FIG. 1, the trough is defined by a bottom wall 145, a first side wall 165, and a second side wall 155 that is preferably U-shaped. A set screw 140 is threaded through a threaded hole in the first side wall 165 in a direction perpendicular to the clamp screws 130 and in a direction towards the second side wall. An end 185 of the set screw 140 together with the second sidewall 155 define an opening 170 for placement of the ground wire 510, as shown in FIG. 5.

During installation, the clamp is attached to a suitable grounding member 500 as shown in FIG. 5 and discussed above. The set screw 140 is loosened such that the end 185 is near flush with the inside surface of the first side wall 165. The opening 170 is consequently enlarged to roughly the full interior portion of the trough with an opening above. The ground wire 510 is “laid-in” via the opening above in the direction 160 shown. The set screw 140 is tightened until the set screw 140 holds the ground wire 510 with fastening pressure between the end 185 and the second side wall 155 of the trough 150, as shown in FIG. 5.

The set screw 140 is preferably a round point screw, i.e., the end 185 is rounded. This is an advantage when a stranded ground wire is used, because the rounded set screw will not cut into the wire like a cup point or flat point screw would.

As shown in FIG. 5, the ground wire 510 is advantageously simply laid-in the trough assembly at some intermediate portion 520 (but not necessarily the middle) of the ground wire 510. This lay-in feature provides the labor savings advantages over the prior art method illustrated in FIG. 6 of inserting the ground wire end-first via an end 630 of the ground wire in a direction 640 through a fully surrounded opening or hole 650 somewhere in the clamp.

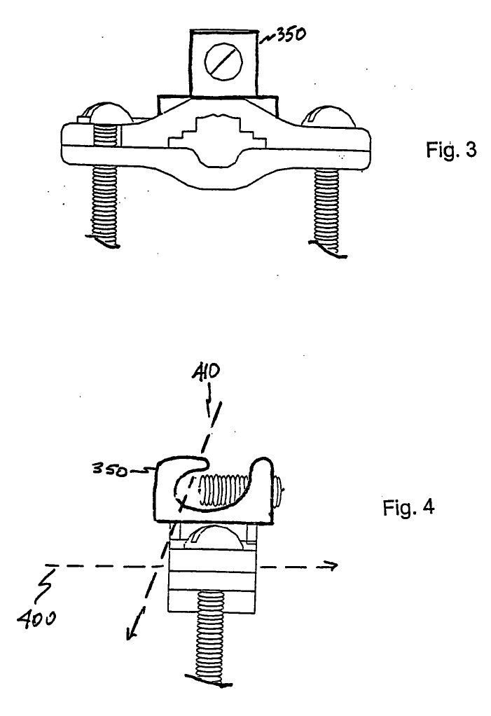

With reference to FIGS. 3 and 4, in another embodiment of the invention the trough 350 is oriented to accommodate a ground wire 410 being laid-in and fastened so that the fastened ground wire 410 is situated in a direction perpendicular with a grounding member 400. Alternatively, the trough 350 can be orientated at any degree from 0 degrees to 360 degrees. The trough 350 can therefore be oriented to serve the application specific installation task optimally.

Referring again to FIGS. 1 and 5, several variations of the embodiments described above are contemplated within the invention. For example, it should also be understood that the trough 350 can be affixed to the bottom clamp member 100 instead, and that the trough 350 need not be positioned at a center point of the top or bottom clamp member 110, 100, but can be off-center.

Additionally, the trough can include, instead of the illustrated set screw 140, a sliding wedge (not shown) that is screw driven to move through the trough 150 and apply force to secure the ground wire 510 to the second wall 155 of the trough. Alternatively, the trough can instead include a snap-on cover (not shown) that bridges the opening between the first and second walls 165, 155 and is installed after the ground wire 510 is inserted, where the snap-on cover is adaptively shaped to apply the needed fastening pressure on the ground wire 510.

The top and bottom clamp members 110, 100 and trough 150 can be made from any conductive alloy, such as a copper alloy, and do not necessarily have to be the same alloy. The screws 130 can be made from various alloys of steel, stainless steel, or copper.

The clamp broadly described herein advantageously allows an installer to lay-in a ground wire from a point above the trough. This feature provides tremendous ease of use and considerable labor/time savings, as the installer simply lays out the approximate length of ground wire needed, then lays it in and secures it with the set screw. There is no concern about pulling and bending the wire, because it does not have to be fed through a small hole, as illustrated in the prior art FIG. 6.

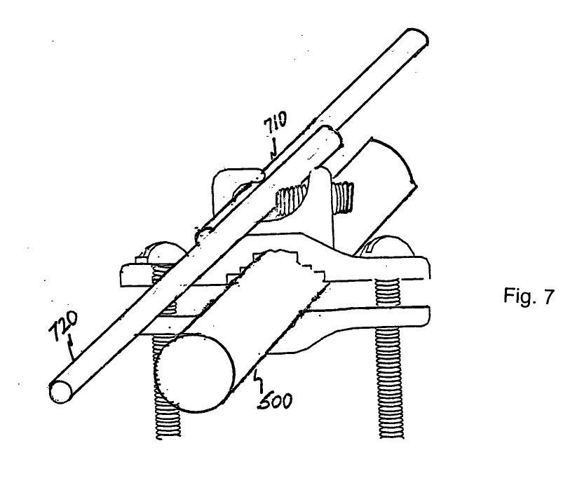

In addition, as illustrated in FIG. 7, the trough 150 can also accommodate the junction of two ground wires 710, 720 that are laid-in side-by-side in the trough 150 and mechanically (and electrically) connected by the imposed clamping pressure of set screw 140. This added advantage allows the installer to begin a new “wire run” with a new ground wire when the end of the previous ground wire is reached without requiring an additional separate device to perform the junction or worse yet the replacement of the ground wire with one long enough to make the entire wire run.

Although the term grounding is used herein in connection with the use of the clamp, it should be understood that this term is not limited to grounding applications per se, but is used generally to encompass several similar applications as well, such as bonding and jumping as defined by the various electrical codes, such as the National Electrical Code (NEC), and various regulatory and testing bodies, such as the National Fire Protection Association (NFPA) and Underwriters Laboratories (UL). Accordingly, the clamping apparatus of the invention is not limited to any one specific application, but is instead intended to be used with a multitude of electrical connectivity related applications.

It should be emphasized that the terms “comprises” and “comprising”, when used in this specification as well as the claims, are taken to specify the presence of stated features, steps or components; but the use of these terms does not preclude the presence or addition of one or more other features, steps, components or groups thereof.

Various embodiments of Applicants' invention have been described, but it will be appreciated by those of ordinary skill in this art that these embodiments are merely illustrative and that many other embodiments are possible. The intended scope of the invention is set forth by the following claims, rather than the preceding description, and all variations that fall within the scope of the claims are intended to be embraced therein.

What is claimed is:

1. A clamping apparatus for electrically connecting at least a first ground wire to a grounding member, the clamping apparatus comprising:
a bottom clamping member comprising a bottom medial portion and a threaded hole on both sides of the bottom medial portion;
a top clamping member cooperating with the bottom clamping member and comprising a top medial portion aligned to cooperate with the bottom medial portion and corresponding holes on either side of a top medial portion that correspond to, and are slightly larger in diameter than, the threaded holes to allow a screw to pass through each hole in the top clamping member and thread into the corresponding threaded hole in the bottom clamping member, thereby providing a clamping action around the ground member between the top and bottom clamping members when the screws are tightened; and
a trough comprising a base wall and a first and second side wall, the trough being attached via the base wall to the top medial portion of the top clamping member on a side opposite the bottom clamping member, the first sidewall comprising a threaded hole and a set screw adapted to tighten against the second sidewall, wherein the trough is arranged with an opening between the first and second sidewall so that the first ground wire can be laid-in the trough at some intermediate point on the ground wire and tightening the set screw applies clamping pressure to the first ground wire between the set screw and the second side wall.

2. The clamping apparatus of claim 1, wherein the trough is oriented so that the clamped first ground wire is situated in a direction substantially parallel to the grounding member.

3. The clamping apparatus of claim 1, wherein the trough is oriented so that the clamped first ground wire is situated in a direction substantially perpendicular to the grounding member.

4. The clamping apparatus of claim 1, wherein one or both of the top and bottom medial portions are crowned in a direction away from the respective other medial portion to create an opening between the top and bottom clamping members for accommodating the grounding member.

5. The clamping apparatus of claim 4, wherein one or both of the crowned medial portion(s) has a serrated surface within the opening between the top and bottom clamping members for accommodating the grounding member.

6. The clamping apparatus of claim 1, wherein the set screw has a rounded end for applying clamping pressure against the first ground wire.

7. The clamping apparatus of claim 1, wherein the set screw further includes a sliding wedge affixed to an end of the set screw, the wedge adapted to move through the trough as the set screw is tightened and to engage the first ground wire for applying clamping pressure against the first ground wire in cooperation with the second sidewall.

8. The clamping apparatus of claim 1, wherein the trough is adapted to accommodate an additional second ground wire laid-in along side the first ground wire in the trough, said first and second ground wires being mechanically and electrically connected by the clamping pressure of set screw.
